(19) United States
(12) Patent Application Publication
(10) Pub. No.: US 2020/0082808 A1
(43) Pub. Date: Mar. 12, 2020

(54) SPEECH RECOGNITION ERROR CORRECTION METHOD AND APPARATUS

(71) Applicant: KIKA TECH (CAYMAN) HOLDINGS CO., LIMITED, Beijing (CN)

(72) Inventors: Chengzhi LI, Beijing (CN); Conglei YAO, Beijing (CN)

(21) Appl. No.: 16/129,269

(22) Filed: Sep. 12, 2018

(51) Int. Cl. G10L 15/02; G10L 15/10; G06F 17/30

(52) U.S. Cl. CPC G10L 15/02; G10L 15/10; G10L 2015/088; G10L 2015/025; G06F 17/30952

(57) ABSTRACT

A speech recognition error correction method and apparatus are provided. The method includes obtaining an original word sequence outputted by an automatic speech recognition (ASR) engine; generating a plurality of candidate word sequences, each candidate word sequence being obtained by substituting one or more subsequence of the original word sequence with one or more corresponding replacement sequence based on a phonetic distance between the subsequence and the replacement sequence; and selecting, among the candidate word sequences, a target word sequence according to generation probabilities of the candidate word sequences. The phonetic distance between the subsequence and the replacement sequence is obtained based on phonetic features of a first phoneme sequence of the subsequence and a second phoneme sequence of the replacement sequence, and the first phoneme sequence and the second phoneme sequence are formed by phonemes used in the ASR engine.

### FIELD OF THE DISCLOSURE

The present disclosure relates to the field of speech recognition technologies and, more particularly, relates to a speech recognition error correction method and apparatus.

### BACKGROUND

Speech recognition technology is applied in voice transcription to improve efficiencies of user input. However, accuracy of speech recognition has become a bottleneck in speech recognition applications. Under practical scenarios, speech recognition results are inevitably disturbed by noise (for example, sound sources in a moving car is disturbed by engine noise), causing inaccurate recognition results.

Error correction techniques are introduced to correct errors in speech recognition results and improve accuracy of speech recognition. Existing error correction techniques detect possible mistakes in speech recognition results based on various language models and correct the mistakes with proper word or phrase. However, these existing techniques omit context or background in speech recognition correction, which causes low accuracy in error correction and discrepancies between correction results and user expectations.

### BRIEF SUMMARY OF THE DISCLOSURE

One aspect of the present disclosure provides a speech recognition error correction method. The method includes: obtaining an original word sequence outputted by an automatic speech recognition (ASR) engine based on an input speech signal; generating a plurality of candidate word sequences, each candidate word sequence being obtained by substituting one or more subsequence of the original word sequence with one or more corresponding replacement sequence based on a phonetic distance between the subsequence and the replacement sequence; and selecting, among the candidate word sequences, a target word sequence according to generation probabilities of the candidate word sequences, the target word sequence being used to correct the original word sequence. Further, the phonetic distance between the subsequence and the replacement sequence is obtained based on phonetic features of a first phoneme sequence of the subsequence and a second phoneme sequence of the replacement sequence, and the first phoneme sequence and the second phoneme sequence are formed by phonemes used in the automatic speech recognition engine.

Another aspect of the present disclosure provides a speech recognition error correction apparatus. The apparatus includes: a memory; and a processor coupled to the memory. The processor is configured to perform: obtaining an original word sequence outputted by an ASR engine based on an input speech signal; generating a plurality of candidate word sequences, each candidate word sequence being obtained by substituting one or more subsequence of the original word sequence with one or more corresponding replacement sequence based on a phonetic distance between the subsequence and the replacement sequence; and selecting, among the candidate word sequences, a target word sequence according to generation probabilities of the candidate word sequences, the target word sequence being used to correct the original word sequence. Further, the phonetic distance between the subsequence and the replacement sequence is obtained based on phonetic features of a first phoneme sequence of the subsequence and a second phoneme sequence of the replacement sequence, and the first phoneme sequence and the second phoneme sequence are formed by phonemes used in the automatic speech recognition engine.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates an exemplary operating environment incorporating certain disclosed embodiments;

FIG. 2 illustrates a block diagram of an exemplary computer system consistent with the disclosed embodiments;

FIG. 3 illustrates a flow chart of an exemplary speech recognition error correction process consistent with the disclosed embodiments;

FIG. 4 illustrates a flow chart of an exemplary process for obtaining a phonetic distance consistent with the disclosed embodiments;

FIG. 5 illustrates an international phonetic alphabet consistent with the disclosed embodiments;

FIG. 6 illustrates a flow chart of an exemplary process for generating candidate word sequences consistent with the disclosed embodiments;

FIG. 7 illustrates a flow chart of another exemplary speech recognition error correction process consistent with the disclosed embodiments;

FIG. 8 illustrates a flow chart of another exemplary process for generating candidate word sequences consistent with the disclosed embodiments;

FIG. 9 illustrates a flow chart of another exemplary speech recognition error correction process consistent with the disclosed embodiments; and

FIG. 10 illustrates a structural diagram of an exemplary speech recognition error correction apparatus consistent with the disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to the drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

The present disclosure provides a method and apparatus for speech recognition error correction. The disclosed error correction process not only applies NLP (Natural Language Processing) techniques, but also combines lexical context and phonetic features, for correcting a recognition result of Automatic Speech Recognition (ASR) engine.

In one embodiment, context-based error correction can be implemented. A language model can be generated to identify probabilities of lexical co-occurrence of any two words in a corpus based on training materials. Using such language model, a word having lowest co-occurrence probability with other words in a fixed length word sequence of an ASR result can be determined and replaced with another word having a higher co-occurrence probability. In another embodiment, multiple subsequences can be obtained from an ASR result. A spelling suggestion API can be used to detect and correct misrecognized words in the multiple subsequences, such as correcting “conputer” to “computer.” After correction with spelling suggestion, the multiple subsequences are combined and evaluated to predict a sentence with highest generation probability based on a language model. Moreover, the disclosed method and apparatus further incorporates phonetic features using customized phonetic distance measurements in speech error correction to improve accuracy.

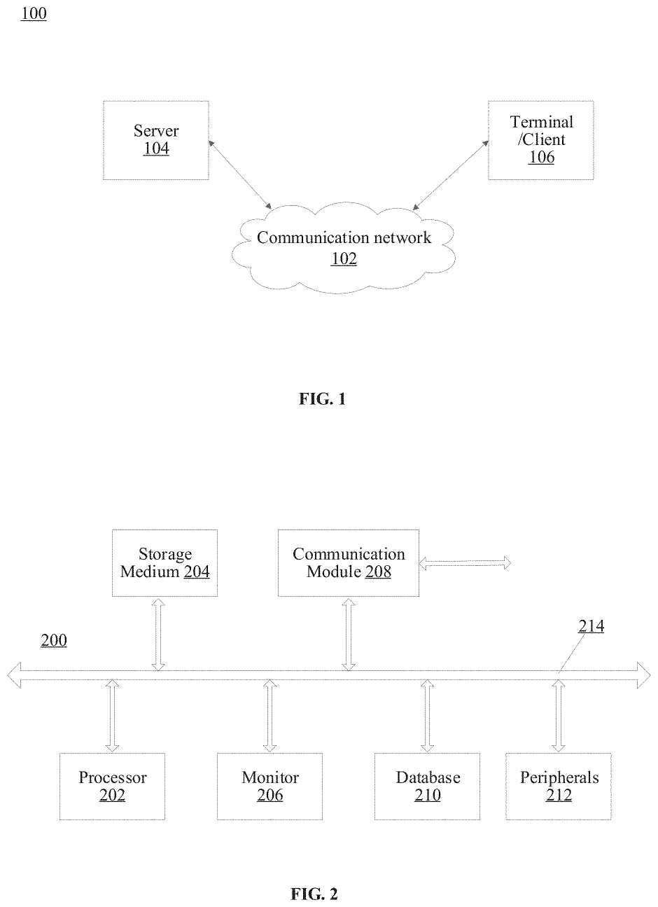

FIG. 1 depicts an exemplary environment 100 incorporating the exemplary methods and computing terminals in accordance with various disclosed embodiments. As shown in FIG. 1, the environment 100 can include a terminal/client 106, a server 104, and a communication network 102. The server 104 and the terminal 106 may be coupled through the communication network 102 for information exchange, e.g., voice signal processing, voice signal generation, chatting in social applications, etc. Although only one terminal 106 and one server 104 are shown in the environment 100, any number of terminals 106 or servers 104 may be included, and other devices may also be included.

The communication network 102 may include any appropriate type of communication network for providing network connections to the server 104 and terminal 106 or among multiple servers 104 or terminals 106. For example, the communication network 102 may include the Internet or other types of computer networks or telecommunication networks, either wired or wireless.

A terminal, or a computing terminal, as used herein, may refer to any appropriate user terminal with certain computing capabilities, e.g., a personal computer (PC), a work station computer, a hand-held computing device (e.g., a tablet), a mobile terminal (e.g., a mobile phone or a smart phone), or any other user-side computing device.

A server, as used herein, may refer to one or more server computers configured to provide certain server functionalities, e.g., voice data analysis and recognition, network data storage, social network service maintenance, and database management. A server may also include one or more processors to execute computer programs in parallel.

The server 104 and the terminal 106 may be implemented on any appropriate computing platform. FIG. 2 shows a block diagram of an exemplary computing system 200 capable of implementing the server 104 and/or the terminal 106. As shown in FIG. 2, the exemplary computer system 200 may include a processor 202, a storage medium 204, a monitor 206, a communication module 208, a database 210, peripherals 212, and one or more bus 214 to couple the devices together. Certain devices may be omitted, and other devices may be included.

The processor 202 can include any appropriate processor or processors. Further, the processor 202 can include multiple cores for multi-thread or parallel processing. The storage medium 204 may include memory modules, e.g., Read-Only Memory (ROM), Random Access Memory (RAM), and flash memory modules, and mass storages, e.g., CD-ROM, U-disk, removable hard disk, etc. The storage medium 204 may store computer programs for implementing various processes (e.g., obtaining and processing voice signal, implementing an automatic speech recognition engine, running navigation application, running a voice input method application, etc.), when executed by the processor 202.

The monitor 206 may include display devices for displaying contents in the computing system 200. The peripherals 212 may include I/O devices, such as keyboard and mouse for inputting information by a user, microphone for collecting audio signals, speaker for outputting audio information, etc. The peripherals may also include certain sensors, such as gravity sensors, acceleration sensors, and other types of sensors.

Further, the communication module 208 may include network devices for establishing connections through the communication network 102 or with other external devices through wired or wireless connection (e.g., Wi-Fi, Bluetooth, cellular network). The database 210 may include one or more databases for storing certain data and for performing certain operations on the stored data, e.g., voice signal processing based on stored reference signals, querying corresponding confusion set of a word, etc.

In operation, the terminal 106 and/or the server 104 can receive and process voice signals for speech recognition. The terminal 106 and/or the server 104 may be configured to provide structures and functions correspondingly for related actions and operations. More particularly, the terminal 106 and/or the server 104 can implement an ASR engine that processes speech signals from a user and outputs a recognition result. Further, the terminal 106 can detect and correct an error in the recognition result from the ASR engine (e.g., in accordance with communications with the server 104) based on NLP techniques and phonetic features.

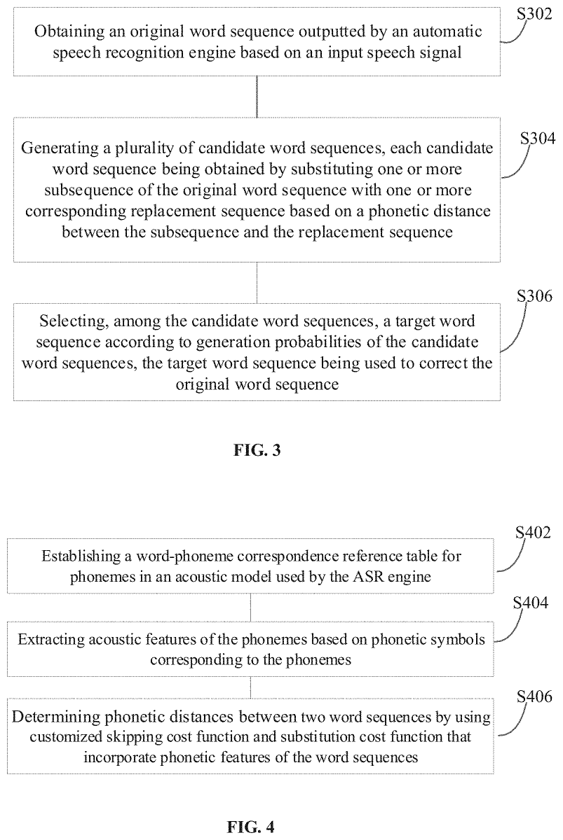

FIG. 3 illustrates a flow chart of an exemplary speech recognition error correction process consistent with the disclosed embodiments. As shown in FIG. 3, the process can include the following steps.

A user device (e.g., terminal 106) can install a voice input method application. The voice input method application is configured to detect and process user-inputted speech signals (e.g., collected by the microphone of the terminal 106) and output speech recognition results. The voice input method application can include or integrate an automatic speech recognition engine. The ASR engine may be deployed and run locally on the terminal 106 or on the cloud (e.g. server 104). The ASR engine can automatically recognize an input speech signal and convert the input speech signal to a text (i.e., a word sequence or a sentence). The ASR engine can integrate both an acoustic model and a language model to implement statistically-based speech recognition algorithms. A language model is a probability distribution over sequences of words, i.e., likelihood that the sequences of words exist based on statistics from a language material corpus. An acoustic model is used in automatic speech recognition to represent the relationship between an audio signal and phonetic units (i.e., phonemes) that make up speech. The acoustic model is learned from a set of audio recordings and their corresponding transcripts. The ASR engine may be commercially available or customized, which is not limited herein.

An original word sequence outputted by the ASR engine based on the input speech signal is obtained (S302). In other words, the original word sequence is a recognition result of the ASR engine. Error correction on the recognition result is performed to improve accuracy.

A plurality of candidate word sentences can be generated based on phonetic features. Specifically, each candidate word sequence can be obtained by substituting one or more subsequence of the original word sequence with one or more corresponding replacement sequence based on a phonetic distance between the subsequence and the replacement sequence (S304). The phonetic distance between the subsequence and the replacement sequence is obtained based on phonetic features of a first phoneme sequence of the subsequence and a second phoneme sequence of the replacement sequence, and the first phoneme sequence and the second phoneme sequence are formed by phonemes used in the automatic speech recognition engine.

A subsequence, as used herein, refers to a word sequence that can be derived from the original word sequence by deleting a elements (i.e., word) without changing the order of the remaining elements, a being an integer no less than 0. The subsequence can be a single word or a plurality of words. For example, when the original word sequence is “how are you,” the subsequence can be “how,” “are,” “you,” “how are,” “are you,” or “how are you.”

A replacement sequence, as used herein, refers to a word sequence used to replace at least a part of the original word sequence for speech recognition error correction. A subsequence can correspond to one or more replacement sequences.

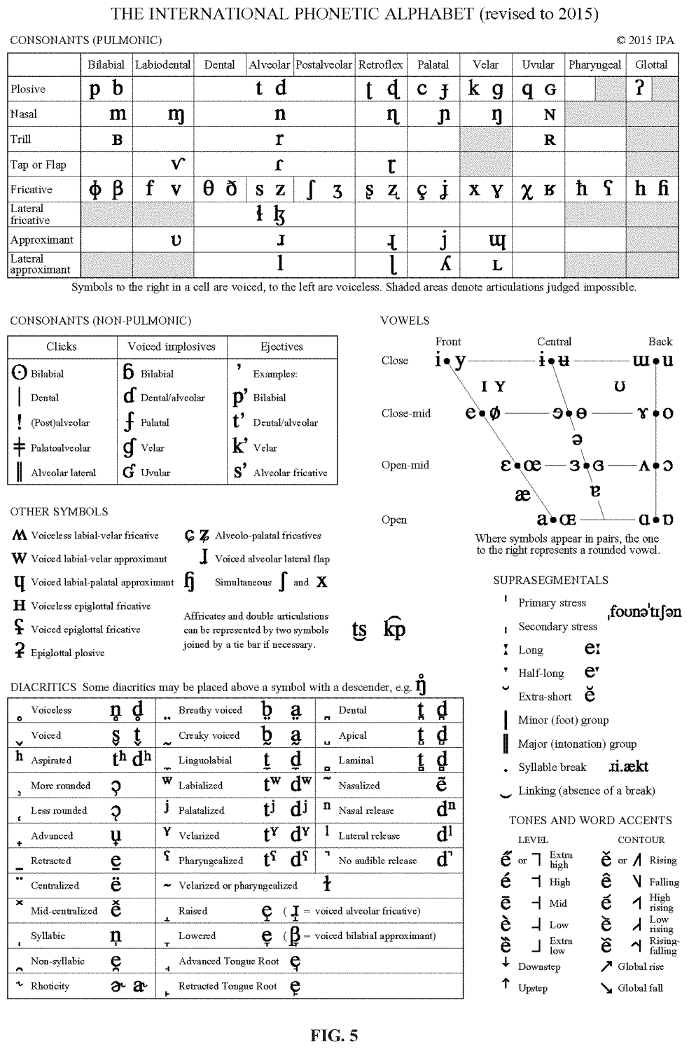

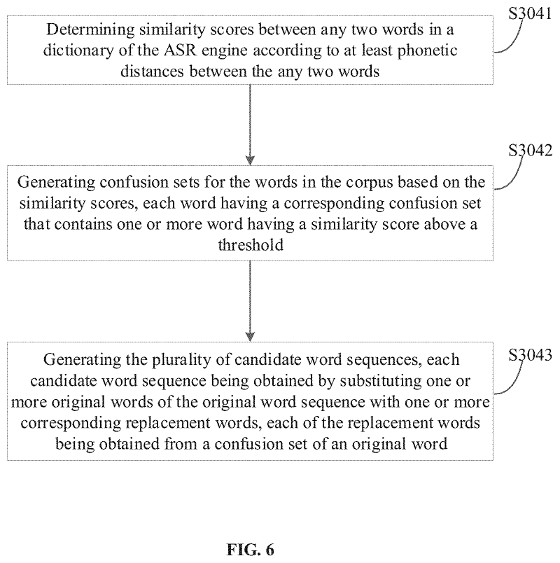

Phonetic distances between word sequences are defined in the disclosed speech recognition error correction process and are explained in detail below. FIG. 4 illustrates a flow chart of an exemplary process for obtaining a phonetic distance consistent with the disclosed embodiments. Specifically, a to-be-corrected content of a speech recognition result should have similar pronunciation with a target content. In other words, a sequence of basic phonetic units (i.e. phonemes) corresponding to the to-be-corrected content is similar to the sequence of phonemes corresponding to the target content based on an acoustic model used by a speech recognition engine.

A word-phoneme correspondence reference table is obtained for phonemes in an acoustic model used by the ASR engine (S402). That is, for each word in a dictionary of the ASR engine, a corresponding phoneme sequence is recorded in the word-phoneme correspondence reference table. The phonme sequences corresponding to the words in the dictionary may be manually marked in the acoustic model used by the ASR engine. Using English as an example, the word “apple” corresponds to a phoneme sequence “ae p ah l”.

Based on the reference table, phoneme sequence of any single word can be obtained. Further, a phoneme sequence of a word sequence formed by multiple words is obtained by concatenating phoneme sequences of the multiple words according to word arranging order in the word sequence. For example, the word “wood” corresponds to a phoneme sequence “w oo d”. Accordingly, word sequence “apple wood” corresponds to a phoneme sequence “ae p ah l w oo d.”

Acoustic features of the phonemes can be extracted based on the corresponding phonetic symbols (S404). Specifically, the phonemes can be marked based on phonetic symbols. Each phoneme in the acoustic model of the ASR engine has a corresponding phonetic symbol. For example, phonetic symbols for the word “apple” is [′æp( [symbol] )l]. Accordingly, the correspondence relationship between phonemes and phonetic symbols include: phoneme “ae” corresponds to phonetic symbol “æ”, phoneme “p” corresponds to phonetic symbol “p”, phoneme “ah” corresponds to phonetic symbol “ [symbol] ”, and phoneme “l” corresponds to phonetic symbol “l”.

Specifically, International Phonetic Alphabet (IPA) can be used to obtain the acoustic features of the phonemes. FIG. 5 illustrates an international phonetic alphabet consistent with the disclosed embodiments. As shown in FIG. 5, phonetic symbols may include consonants, vowels, diacritics, etc. Feature fields can be selected and used to present categories of acoustic features of the phonetic symbols in the phonetic alphabet. For each category of acoustic feature, variations of subcategories (i.e., subcategory phonological terms) can be assigned with different numerical values which can be used in feature extraction of the phonemes.

Using consonants as an example, at least two feature fields can be selected: place of articulation (hereinafter also referred as Place) and manner of articulation (hereinafter also referred as Manner). Place of articulation is the point of contact where an obstruction occurs in the vocal tract between an articulatory gesture, an active articulator (typically some part of the tongue), and a passive location (typically some part of the roof of the mouth). The places of articulation for a consonant include, for example, Bilabial, Labio-dental, Dental, Alveolar, Post-alveolar, Retro-flex, Palatal, Velar, Uvular, Pharyn-geal, and Glottal. A manner of articulation is the configuration and interaction of the articulators (speech organs such as the tongue, lips, and palate) when making a speech sound. The manners of articulation can include, for example, Stop, Affricate, Thrill, Flap/tap, Fricative, Lateral fricative, Approximant, Lateral approximant.

Numerical values can be assigned for each phonological term (i.e., subcategory of a feature field) as feature values. Table 1 below shows exemplary numerical values assigned to different phonological situations in the two feature fields corresponding to a consonant.

TABLE 1

| Feature Name | Phonological term | Numerical value |
|---|---|---|
| Place | [bilabial] | 1.0 |
| | [labiodental] | 0.95 |
| | [dental] | 0.9 |
| | [alveolar] | 0.85 |
| | [retroflex] | 0.8 |
| | [palate-alveolar] | 0.75 |
| | . . . | . . . |
| Manner | [stop] | 1.0 |
| | [affricate] | 0.9 |
| | [fricative] | 0.8 |
| | [approximant] | 0.6 |
| | . . . | . . . |

For example, the Place for phonetic symbol “t” is Alveolar, and the Manner for phonetic symbol “t” is Stop. Accordingly, feature value of Place feature for phonetic symbol “t” is 0.85, feature value of Manner feature for phonetic symbol “t” is 1.0.

In addition, other categories of acoustic features can be used to describe a consonant as feature fields, such as Syllabic, Voice, Lateral, etc. Values for these features can be either 1 or 0 depending on whether the phonetic symbol fits the feature description or not.

Each category of feature (feature field) is assigned with a corresponding weight. Table 2 below shows exemplary assigned weights for multiple feature fields.

TABLE 2

| | | | |
|---|---|---|---|
| Place | 40 | Manner | 50 |
| High | 30 | Back | 30 |
| Round | 10 | Syllabic | 10 |
| Voice | 10 | Nasal | 10 |
| Retroflex | 10 | Lateral | 10 |

Returning to FIG. 4, phonetic distance between two word sequences can be determined based on their phonetic features (S406). A phoneme sequence of a word sequence can be obtained based on the word-phoneme correspondence reference table. A phoneme sequence representing the word sequence can be denoted as sequence x. For example, sequence x for word “apple” is “ae p ah l”. Each phoneme in the phoneme sequences are used in the acoustic model of the ASR engine.

In some embodiments, obtaining the phonetic distance can include: extracting the phonetic features associated with the phonemes based on a phonetic alphabet corresponding to the phonemes; defining a skipping cost function that evaluate a phonetic difference for skipping a phoneme in a phoneme sequence based on the phonetic features; defining a substitution cost function that evaluate a phonetic difference for substituting a phoneme with another phoneme in a phoneme sequence based on the phonetic features; and according to the skipping cost function and the substitution cost function, defining the phonetic distance as a minimum number of operations required to transform the first phoneme sequence to the second phoneme sequence, the operations including: skipping a phoneme and substituting a phoneme. In addition, extracting the phonetic features (e.g., in accordance with step S404) can include: selecting a plurality of feature fields based on phonetic categories in the phonetic alphabet corresponding to the phonemes used in the acoustic model; assigning feature values for subcategory phonological terms in each of the plurality of feature fields; for each of the plurality of feature fields, assigning a corresponding weight; and calculating the skipping cost function and the substitution cost function based on the assigned feature values and the assigned weights.

Specifically, a phonetic distance between two phoneme sequences can be determined in a manner similar to obtaining a minimum edit distance by using customized skipping cost function and substitution cost function that incorporate the phonetic features of the phonemes (e.g., assigned feature values and weights). In one embodiment, phonetic distance between phoneme sequence x and phoneme sequence y can be obtained by counting the minimum number of operations required to transform the phoneme sequence y into the phoneme sequence x, the operations including two types: skipping a phoneme and substitute a phoneme with another phoneme.

A skipping cost function σₛₖᵢₚ(m) shown below is defined to evaluate phonetic outcome of skipping a phoneme m. A substitution cost function σ_{sub}(m,n) shown below is defined to evaluate phonetic outcome of substituting one phoneme m with the other phoneme n.

$${σ}_{skip} ( m ) = {\sum }_{f ϵ R} f ( m ) * salience ( f )$$

$${σ}_{sub} ( m , n ) = {\sum }_{f ϵ R} diff ( m , n , f ) * salience ( f )$$

where R denotes feature fields. Specifically,

$$R = \{ \begin{matrix}Place , Manner , Syllabic , Voice , Nasal , Retroflex , Lateral \\ if m or n is a constant \\ High , Back , Round , Syllabic , Nasal , Retroflex otherwize\end{matrix}$$

f( ) denotes a function to obtain a feature value for a feature field of the phoneme.
salience(f) denotes a function to obtain a weight corresponding to the feature field.
diff(m,n,f)=|f(m)−f(n)|, which denotes a function to obtain an absolute value of a difference value between f(m) and f(n) for a feature field.

The phonetic distance Distance(i,j) denotes minimum number of operations required to transform a phoneme sequence formed by x₁ to xᵢ and a phoneme sequence formed by y₁ to yⱼ, and is defined by:

$$Distance ( i , j ) = min ( \begin{matrix}Distance ( i - 1 , j ) + {σ}_{skip} ( {x}_{i} ) , \\ Distance ( i , j - 1 ) + {σ}_{skip} ( {y}_{j} ) , \\ Distance ( i - 1 , j - 1 ) + {σ}_{sub} ( {x}_{i} , {y}_{j} )\end{matrix} ) , \\ i \leq \vert x \vert , j \leq \vert y \vert$$

Dynamic planning can be implemented to solve the above-defined problem. The calculation starts at i=1, j=1, and ends at i=|x|, j=|y|. Accordingly, Distance(x,y) can be obtained when i=|x|, j=|y|. It can be understood that, the smaller the phonetic distance is, the more similar the two phoneme sequences are, and the closer the two word sequences sound/pronounced.

In this way, a phonetic distance between any two word sequences can be obtained. Further, word sequences that are variations of the original distance and that have low phonetic distance to the original word sequence can be obtained as the candidate word sequences.

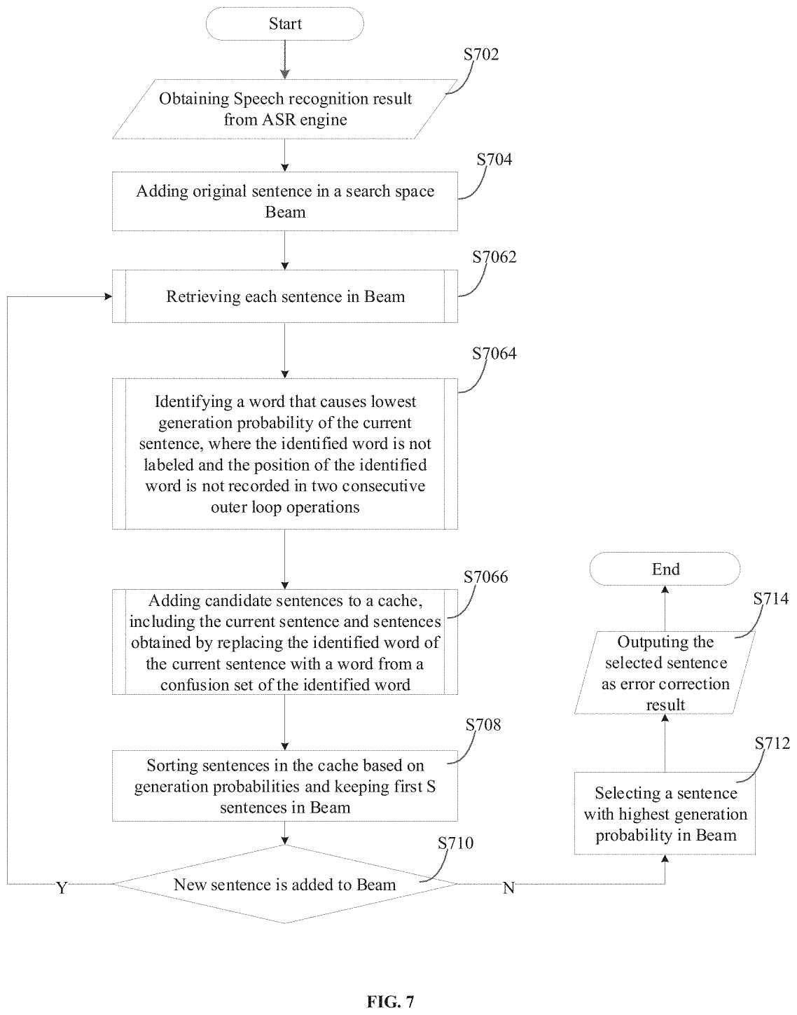

In some embodiments, in an automatic correction mode, multiple replacement sequences corresponding to a subsequence may be obtained from a predetermined confusion set of the subsequence. The confusion set of the subsequence stores the multiple word sequences having high similarity with the subsequence based on at least their phonetic features. Candidate word sequences can be generated by replacing a subsequence with each of the corresponding replacement sequence in the confusion set. Embodiments consistent with the automatic correction mode is further described below in accordance with FIG. 6 and FIG. 7.

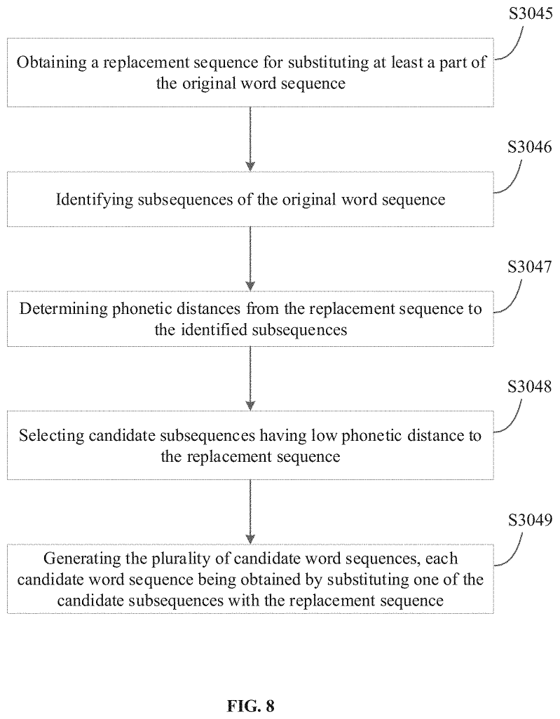

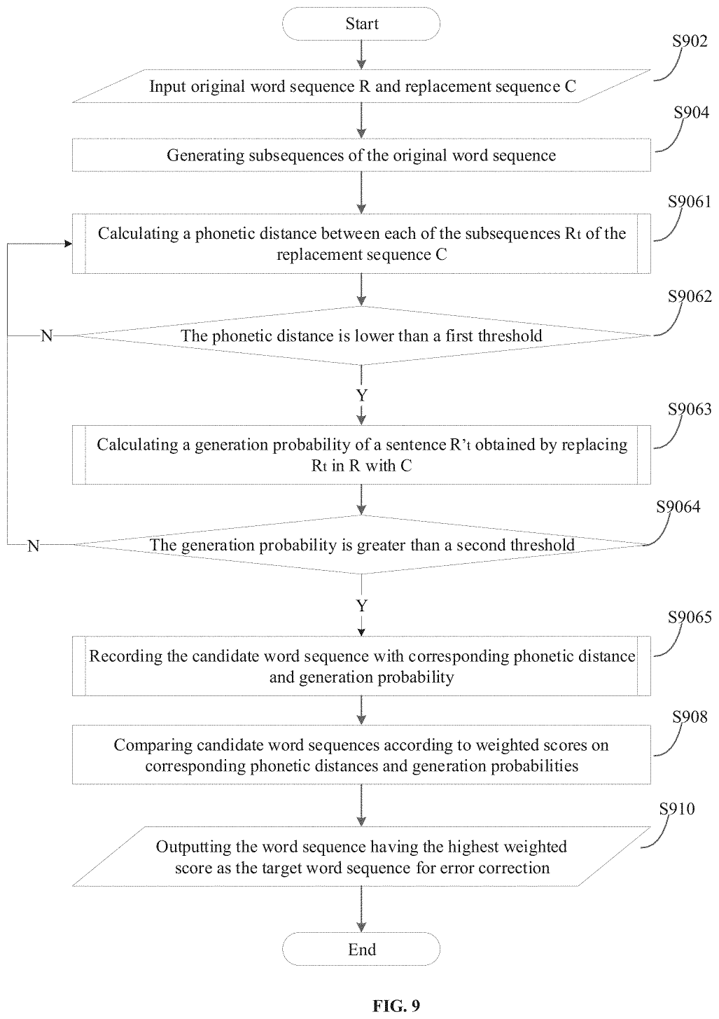

In some embodiments, in a manual correction mode, one replacement sequence may be directly obtained from the ASR engine after the user device receives a second speech signal for correcting the original word sequence. Multiple subsequences of the original word sequence having a smaller phonetic distance to the replacement sequence can be identified. Candidate word sequences can be generated by replacing each of the identified subsequences with the one replacement sequence. Embodiments consistent with the manual correction mode is further described below in accordance with FIG. 8 and FIG. 9.

Returning to FIG. 3, a target word sequence can be selected among the candidate word sequences according to generation probabilities of the candidate word sequences (S306). The target word sequence is used to correct the original word sequence.

Specifically, a natural language processing model (e.g., n-gram model) can be applied to determine a generation probability of a word sequence. For example, if a n-gram model is used, a predicted probability of a word is a conditional probability of the word occurs given that n−1 previous words exist in the current sentence (i.e., word sequence). Based on the language model, each word in the word sequence has a corresponding predicted probability. A generation probability of a word sequence can be a product of predicted probabilities of all words in the word sequence.

In some embodiments, the target word sequence can be the one that has the highest generation probability among all the candidate word sequences. In some embodiments, the target word sequence can be selected based on two factors: the generation probabilities and the phonetic distances to the original word sequence. For example, weighted scores incorporating both factors can be determined to evaluate the candidate word sequences. The target word sequence can be the one that has the highest weighted score among all the candidate word sequences.

As such, the disclosed method provides a speech recognition error correction process incorporating phonetic features of phoneme sequences evaluated by specifically defined phonetic distance, which provides a unique and efficient representation of the phonetic features and can be easily used in error correction to improve recognition accuracy. Particularly, the phonemes used in evaluating the phonetic distances are the same as those used in the acoustic model of the ASR engine, such that the disclosed method is more sensitive in identifying words that mixed up (recognized by mistake) by the ASR engine.

In some embodiments, confusion sets of words used in the ASR engine based on phonetic distances can be obtained to generate candidate word sequences. FIG. 6 illustrates a flow chart of an exemplary process for generating candidate word sequences consistent with the disclosed embodiments. As shown in FIG. 6, step S304 can further include the following process.

Specifically, a dictionary (i.e., vocabulary) of the ASR engine includes a plurality of words (e.g., all possible words used in speech recognition). For each word in the ASR engine, a confusion set (or a fuzzy set) corresponding to the word which collects other words that most likely to be confused with the word can be generated.

Similarity scores between any two words in a dictionary of the ASR engine can be determined according to at least phonetic distances between the any two words (S3041). Phonetic distances between a target word and all remaining words contained in the dictionary may be calculated. Accordingly, a similarity score Similarityₚ(q) between a target word p and any one of the remaining words q in the dictionary/vocabulary can be calculated as follows

$${Similarity}_{p} ( q ) = 1 - \frac{PhoneticDistance ( p , q )}{{Max}_{w ∈ Vocabulary} ( PhoneticDistance ( p , w ) )}$$

where Max_{w∈Vocabulary}(PhoneticDistance(p,w)) denotes a maximum value among all phonetic distances obtained between the word p and the remaining words in the vocabulary.

In some embodiments, other factors may also be considered when determining the confusion set comprehensively, such as edit distance and word frequency in a corpus. Edit distance describes how dissimilar two strings (e.g., words) are to one another by counting minimum number of operations required to transform one string into the other. That is, smaller edit distance indicates strings of two words are more similar. Word frequency in a corpus describes how many times a word occurs in a given collection of texts (i.e., corpus, training transcripts) in a language corresponding to the text.

Accordingly, a similarity score determined based on both phonetic distance and edit distance can be calculated as

$${Similarity}_{p} ( q ) = α ( 1 - \frac{PhoneticDistance ( p , q )}{{Max}_{w ϵ Vocabulary} ( PhoneticDistance ( p , w ) )} ) + ( 1 - α ) ( 1 - \frac{EditDistance ( p , q )}{Length ( p )} ) , α ∈ [ 0 , 1 ]$$

where Length(p) denotes number of characters included in word p, and α is a weight parameter that can be adjusted according to desired requirements. If α is adjusted to a higher value, the similarity score becomes more dependent on the phonetic distance; if α is adjusted to a lower value, the similarity score becomes more dependent on the edit distance.

Further, a similarity score determined based on phonetic distance, edit distance, and word frequency can be calculated as

$${Similarity}_{p} ( q ) = α ( 1 - \frac{PhoneticDistance ( p , q )}{{Max}_{w ∈ Vocabulary} ( PhoneticDistance ( p , w ) )} ) + β ( 1 - \frac{EditDistance ( p , q )}{Length ( p )} ) + γ \frac{c ( q )}{{\sum }_{w ∈ Vocabulary} c ( w )} , \\ α , β , γ ∈ [ 0 , 1 ] , α + β + γ = 1$$

where c(q) denotes word frequency of word q, Σ_{w∈Vocabulary}c(w) denotes a sum of word frequencies of all words in the vocabulary, and α, β, γ are parameters corresponding to the three factors respectively. These parameters can be adjusted based on desired requirements.

Based on the similarity scores, the confusion set of word p can be generated (S3042). Specifically, a word q may be added to the confusion set if its corresponding similarity score is higher than a preset threshold and ranks at the first preset number of words in a word list sorted in a descending order based on similarity scores. For example, 25 words are identified as having a similarity score (regarding word p) above the preset threshold. The 25 words are sorted in a descending order based their similarity scores and the first 10 words in the sorted list are added to the confusion set corresponding to word p.

In some embodiments, the ASR engine may support multi-language speech recognition. That is, the ASR includes vocabularies for multiple languages. A similarity score of a word p with a word q1 in a same language vocabulary can be calculated based on the above-disclosed equation using a first set of parameters α1, β1, and/or γ1. A similarity score of a word p with a word q2 in different language vocabularies can be calculated use the above-disclosed equation using a second set of parameters α2, β2, and/or γ2. Further, Vocabulary used for similarity score generation may denote the vocabulary corresponding the language of word q or a combined vocabulary of some or all languages supported in multi-language mode of the ASR engine. In this way, a first confusion set of the word p corresponding to a single language can be obtained based on similarity scores calculated with the first set of parameters and used in a single language speech recognition mode. A second confusion set of the word p corresponding to multiple languages can be obtained based on similarity scores calculated with the second set of parameters (and/or combined vocabulary) and used in a multi-language language speech recognition mode. It can be understood that the two confusion sets in the single language mode and the multi-language mode may not include exact same words.

When the confusion sets corresponding to all words in the vocabulary of the ASR are established, error correction of speech recognition results can be implemented accordingly. It can be understood that the confusion sets of all words in the dictionary of the ASR engine can be predetermined and stored on the user device and/or the server before processing the original word sequence. In operation, after the original sequence is obtained, candidate word sequences can be generated, each candidate word sequence being obtained by substituting one or more original words of the original word sequence with one or more corresponding replacement words, each of the replacement words being obtained from a confusion set of an original word (S3043).

FIG. 7 illustrates a flow chart of an exemplary speech recognition error correction process in accordance with the process described in FIG. 3 and FIG. 6. As shown in FIG. 7, the user device may record speech signals from a user and obtain a speech recognition result by using an ASR engine (S702). Errors in the recognition result may be corrected using the confusion sets generated based on phonetic distances. Specifically, a text recognized by ASR according to speech signal is considered as an initial sentence (i.e., original word sequence). The error correction steps may include the following.

S704. The initial sentence is added to a search space denoted as Beam. In some embodiments, the search space is a cache area designated for storing candidate sentence(s).

An outer loop operation including steps S706-S710 is performed to evaluate all sentences in the current search space Beam. Further, Step S706 includes inner loop operations step S7062-S7066, which are repeated for each sentence contained in Beam. For example, if Beam includes S sentences, the inner loop is iterated for S times. The search space (e.g., a cache area) starts out as having S sentences, may be added with new sentences along the iterations of the inner loop operations (e.g., step S7066), and may have certain sentences removed at the end of the outer loop operation (e.g., S708). In some embodiments, the S sentence(s) at the beginning of the loop operation are marked. It can be understood that, at the first iteration of outer loop operation, the search space includes one sentence, i.e., the original sentence. Specifically, in one inner loop iteration, a sentence in the search space Beam is retrieved (S7062).

S7064. For a sentence currently being processed (i.e., the sentence retrieved in step S7062), a natural language processing model (e.g., n-gram model) is applied to identify a word in the current sentence that causes lowest generation probability of the current sentence based on predictions of the language model, provided that the word is not labeled and a position of the identified word is not recorded in two consecutive outer loop operations. For example, if a n-gram model is used, a predicted probability of a word is a conditional probability the word occurs given that n−1 previous words exist in the current sentence. Each word has a corresponding predicted probability. A generation probability of a sentence can be a product of predicted probabilities of all words in the current sentence. That is, the word that causes lowest generation probability can be identified by finding a word having the lowest predicted probability. In other words, the word that causes lowest generation probability of the sentence is most likely to be the error in the ASR recognition result. Further, the location of the identified word is recorded.

If it is determined that the identified word is labeled, or a position of the identified word is recorded in two consecutive outer loop operations, such word is excluded from consideration for the word having lowest predicted probability. In some embodiments, such word may be excluded from the sentence first, and the language model can then be applied in remaining words in the sentence to identify the word causing lowest generation probability of the sentence (i.e., the word having lowest predicted probability). If it is determined that the identified word is not labeled, and a position of the identified word is not recorded in two consecutive outer loop operations, the position of the identified word is recorded, and the process moves on to step S7066. In this way, same position/word in the sentence cannot be identified again in two consecutive outer loop operations.

S7066. Candidate sentences are added to the cache. That is, the search space includes: the current sentence (e.g., retrieved in step S7062 that already in the cache) and sentences obtained by replacing the identified word (i.e., identified in step S7064) of the current sentence with a word from a confusion set of the identified word (e.g., step 3043 in FIG. 6). A confusion set corresponding to the identified word can be obtained from a prestored confusion set database (e.g., obtained by implementing steps S3041-S3042 in FIG. 6). For example, when the confusion set includes N words, N new sentences can be generated by replacing the identified word in the current sentence with one of the N words, and added to the cache. Accordingly, the cache includes N+1 sentences (the N new sentences and the current sentence). In some embodiments, hash can be used to ensure that same sentence is not added into the cache twice. Further, the replaced word in each of the new N sentences is labeled such that it will not be identified/replaced again in following outer loop iterations. Generation probabilities for each of the N+1 sentences may be determined based on the language model. That is, each sentence in the cache has a corresponding generation probability.

S708. After all sentences in Beam are processed in the inner loop according to steps S7062-S7066, sentences in the cache are sorted in a descending order based on their corresponding generation probabilities, and sentences with low generation probabilities are removed from the cache. The generation probabilities of the sentences can be obtained from the language model. Removing sentences with low generation probabilities can limit the search space and reduce computation complexity. In one example, the first preset number S of sentences (i.e., first S sentences in the sorted list) are kept in Beam and remaining sentences are deleted. In another example, sentences with generation probabilities lower than a threshold are deleted.

S710. Beam is evaluated to determine whether any new sentence is added (e.g., as a result of the current outer loop operation). In some embodiments, if the search space Beam includes an unmarked sentence, it is determined that a new sentence is added. When it is determined that one or more new sentences are added, and the process return to step S7062 for the next iteration. When no new sentence is added, the outer loop operation is stopped, and the process moves on to step S712.

S712. The sentence in the search space Beam with highest generation probability is obtained.

S714. The obtained sentence is outputted as the error correction result (i.e., target word sequence) of the text recognized by ASR. It can be understood that, steps S702-714 are automatically performed by the user device in response to an ASR recognition result. In other words, when speech signal is collected from the user, the user device performs automatic speech recognition and automatic error correction on the speech recognition result. In this way, the voice input method application can directly output and display the target word sequence (error correction result).

In some embodiments, one replacement sequence is provided to generate candidate word sequences. FIG. 8 illustrates a flow chart of an exemplary process for generating candidate word sequences consistent with the disclosed embodiments. As shown in FIG. 8, step S304 can further include the following process.

A replacement sequence for substituting at least a part of the original word sequence is obtained (S3045). Specifically, when the speech signal is obtained and processed, the user device may directly output the recognition result of the ASR engine (i.e., the original word sequence) and obtain user input that indicates whether error correction is needed. When the user is satisfied with the outputted result, the user device does not need to perform error correction. When the user indicates that error correction is needed, the user device is further configured to collect a consecutive speech signal directed to correct (i.e., replace) at least part of the original word sequence. The ASR engine can analyze and convert the consecutive speech signal to a text (i.e., the replacement sequence). The replacement sequence (e.g., obtained from the consecutive speech signal) is used for substituting at least a part of the original word sequence.

Subsequences of the original word sequence are identified (S3046). In some embodiments, the user device can obtain all possible subsequences of the original word sequence.

Further, phonetic distances from the replacement sequence to the identified subsequences can be determined (S3047). Specifically, a phoneme sequence of the replacement sequence can be obtained, and phoneme sequences of the subsequences can be obtained. The phonetic distance from the replacement sequence to an identified subsequence can be obtained using previously defined phonetic distance equations based on phonetic features of their corresponding phoneme sequences.

Candidate subsequences having low phonetic distance to the replacement sequence can be selected (S3048). In one embodiment, a subsequence whose corresponding phonetic distance is lower than a threshold is selected as one of the candidate subsequences. In another embodiment, a subsequence whose corresponding phonetic distance ranks among the first preset number of all subsequences is selected as one of the candidate subsequences.

Accordingly, the plurality of candidate word sequences can be generated (S3049). A candidate word sequence is obtained by substituting one of the candidate subsequences in the original word sequence with the replacement sequence.

FIG. 9 illustrates a flow chart of an exemplary speech recognition error correction process in accordance with the process described in FIG. 3 and FIG. 8. The process is directed to correct the recognition result based on user input. As shown in FIG. 9, an original word sequence R and a replacement sequence C are obtained (S902).

Specifically, a first text (i.e., the original word sequence) recognized according to a speech signal is presented to the user. When the user does not agree with the recognized text, the device may collect speech signal from the user identifying user correction content. The user correction content is recognized by the ASR engine as a second text (i.e., the replacement sequence). The second text can be a word or a phrase used to replace a corresponding word or phrase in the first text. The first text is denoted as R and the number of words contained in the first text is denoted as |R|. The replacement sequence is denoted as C.

Accordingly, subsequences of the original word sequence can be obtained (S904). A subsequence of the original word sequence is denoted as Rₜ. For an original word sequence including |R| words, |R|(|R|+1)/2 subtexts (i.e., subsequences) can be obtained. That is, t ranges from 1 to |R|(|R|+1)/2. Here, the subtext refers to a consecutive word sequence included in the first text or a word included in the first text. The error correction result can be determined based on phonetic distance from a subsequence to the replacement sequence and generation probability of a sentence obtained by replacing a subsequence in the original word sequence with the replacement sequence.

In some embodiments, steps S9061-S9065 are repeated for each of the subsequences Rₜ to evaluate the subsequences. Accordingly, the iteration is performed |R|(|R|+1)/2 times.

Specifically, a phonetic distance Distance(phoneme(Rₜ),phoneme(C)) between a subsequence Rₜ and the replacement subsequence C can be calculated (S9061). In other words, a phonetic distance between a phoneme sequence of a subsequence and a phoneme sequence of the replacement sequence is calculated. The user device determines whether the phonetic distance is small enough (S9062). When the phonetic distance is less than a first threshold, the process moves on to step S9063. When the phonetic distance is not less than the first threshold, the process returns to step S9061 to evaluate the next subsequence if there is a remaining subsequence not iterated/processed yet.

A word sequence variation R′ₜ can be obtained by replacing the subsequence Rₜ in the original word sequence R with the replacement sequence C. A generation probability P(R′ₜ) of the word sequence variation can be obtained using a language model (S9063). The user device then determines whether the generation probability is high enough (S9064). When the generation probability is greater than a second threshold, the process moves on to step S9065. When the generation probability is not greater than the second threshold, the process returns to step S9061 to evaluate the next subsequence if there is a remaining subsequence not iterated/processed yet.

When R′ₜ satisfies both requirements on the phonetic distance and the generation probability, R′ₜ is considered as a candidate word sequence and added to a candidate pool. The phonetic distance Distance(phoneme(Rₜ),phoneme(C)) and generation probability P(R′ₜ) corresponding to the candidate word sequence are recorded (S9065). It can be understood that in some embodiments, the process may perform steps S9063-S9064 before performing steps S9061-S9062 and the result at the end of current iteration should be the same. Further, at the end of step S9065, the process returns to step S906 to evaluate the next subsequence if there is a remaining subsequence not iterated/processed yet.

When all subsequences are processed, candidate word sequences in the candidate pool are further compared to determine the target word sequence (S908). Specifically, a weighted score can be obtained for each candidate word sequence based on its corresponding phonetic distance and generation probability. For example, a weight assigned to phonetic distance is denoted as w1, and a weight assigned to generation probability is denoted as w2. The score of candidate word sequence can be a weighted sum of the two factors, i.e., w1*Distance(phoneme(Rₜ),phoneme(C))+w2*P(R′ₜ).

The candidate word sequence having the highest weighted score is selected as the target word sequence for error correction output (S910).

Here, it is assumed that the second text (i.e., the replacement sequence) is recognized correctly by the ASR engine. In some embodiments, the automatic error correction process in accordance with FIG. 7 may be implemented on the second text to obtain a corrected replacement sequence C for S902.

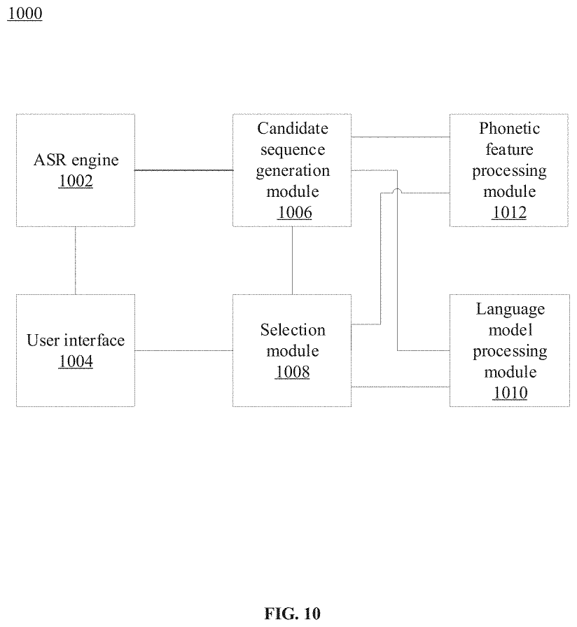

The present disclosure further provides a speech recognition error correction apparatus. FIG. 10 illustrates a structural diagram of an exemplary speech recognition error correction apparatus 1000 consistent with the disclosed embodiments. The apparatus 1000 can be implemented by, for example, the computing system 200 shown in FIG. 2. The apparatus 1000 may include a memory, a processor, an audio input device (e.g., a microphone), and a display. The memory may store a plurality of program modules to be executed by the processor. As shown in FIG. 10, the program modules include an ASR engine 1002, a user interface 1004, a candidate sequence generation module 1006, a selection module 1008. In some embodiments, the program modules may further include a probability language model processing module 1010 and a phonetic feature processing module 1012. In operation, the apparatus 1000 may implement the processes described in FIGS. 3-4 and 7-9.

The ASR engine 1002 is configured to receive a speech signal collected by the audio input device, and automatically convert the speech signal to a text. Depending on application scenarios, the text can be an original word sequence that needs to undergo error correction, or a replacement sequence that used to substitute at least a part of the original word sequence.

The user interface 1004 is configured to display instructions, status and outcomes related to speech recognition and error correction. The user interface 1004 can be an interface of a speech input method application. For example, when the speech input method application is activated, the user interface 1004 may display an icon indicating that a speech signal is being recorded. When the selection module 1008 outputs an error correction result, the user interface 1004 may display the error recognition result. In some embodiments, when the speech signal is processed by the ASR engine 1002, the user interface 1004 may display an ASR recognition result. The user interface 1004 may further solicit and monitor user input on whether the ASR recognition result needs to be corrected. In some embodiments, the user interface 1004 may provide error correction mode options for user selection (e.g., on a settings interface or input interface of the speech input method application), the options including an automatic correction mode and a manual correction mode. When the automatic correction mode is selected, the apparatus 1000 may implement the processes disclosed in FIG. 6 and/or FIG. 7. When the manual correction mode is selected, the apparatus 1000 may implement the processes disclosed in FIG. 8 and/or FIG. 9.

The candidate sequence generation module 1006 is configured to generate plurality of candidate word sentences based on phonetic features. Specifically, each candidate word sequence can be obtained by substituting one or more subsequence of the original word sequence with one or more corresponding replacement sequence based on a phonetic distance between the subsequence and the replacement sequence. The candidate sequence generation module 1006 may perform steps S3041-S3043 as shown in FIG. 6 and/or steps S3045-S3049 as shown in FIG. 8.

The selection module 1008 is configured to select a target word sequence among the candidate word sequences according to generation probabilities of the candidate word sequences. The target word sequence is used to correct the original word sequence and output on the user interface 1004 as error correction result. The selection module 1008 may perform step S306 as shown in FIG. 3.

The probability language model processing module 1010 is configured to, when given a word sequence, calculate a generation probability of the word sequence based on a language model (e.g., the likelihood that the word sequence occurs based on statistics and vocabulary). The candidate sequence generation module 1006 and/or the selection module 1008 may query the probability language model processing module 1010 whenever a generation probability of a word sequence is required.

The phonetic feature processing module 1012 is configured to calculate a phonetic distance between two word sequences. The candidate sequence generation module 1006 and/or the selection module 1008 may query the phonetic feature processing module 1012 whenever a phonetic distance is required. The phonetic feature processing module 1012 calculates the phonetic distance as described in steps S406 in FIG. 4. In some embodiments, the phonetic feature processing module 1012 may store confusion sets of words, and the candidate sequence generation module 1006 can query the phonetic feature processing module 1012 to obtain words with low phonetic distance to an original word in the original word sequence for replacement, and generate a candidate word sequence using a word in the confusion set. In some embodiments, the selection module 1008 is further configured to select a target word sequence among the candidate word sequences according to generation probabilities of the candidate word sequences obtained from the probability language model processing module 1010 and phonetic distances between the candidate word sequences and replacement sequence obtained from the phonetic feature processing module 1012.

The disclosed method and apparatus can improve accuracy of speech recognition. Phonemes used in automatic search engine are the same as those used in calculating phonetic distances, which allows the process to accurately locate words easily confused by the ASR and perform speech recognition error correction. Further, two error correction modes (automatic and manual) are disclosed, the input method application can allow the user to choose from either mode for speech recognition. In this way, speech input efficiency is increased, and free users from hand operations.

As disclosed herein, the disclosed methods and mobile terminal may be accomplished by other means. The mobile terminals as depicted above in accordance with various embodiments are exemplary only. For example, the disclosed modules/units can be divided based on logic functions. In actual implementation, other dividing methods can be used. For instance, multiple modules or units can be combined or integrated into another system, or some characteristics can be omitted or not executed, etc.

In various embodiments, the disclosed modules for the exemplary system as depicted above can be configured in one device or configured in multiple devices as desired. The modules disclosed herein can be integrated in one module or in multiple modules for processing messages. Each of the modules disclosed herein can be divided into one or more sub-modules, which can be recombined in any manners.

In addition, each functional module/unit in various disclosed embodiments can be integrated in a processing unit, or each module/unit can exist separately and physically, or two or more modules/units can be integrated in one unit. The integrated units as disclosed above can be implemented in the form of hardware and/or in the form of software functional unit(s).

When the integrated modules/units as disclosed above are implemented in the form of software functional unit(s) and sold or used as an independent product, the integrated units can be stored in a computer readable storage medium. Therefore, the whole or part of the essential technical scheme of the present disclosure can be reflected in the form of software product(s). The computer software product(s) can be stored in a storage medium, which can include a plurality of instructions to enable a computing device (e.g., a mobile terminal, a personal computer, a server, a network device, etc.) to execute all or part of the steps as disclosed in accordance with various embodiments of the present disclosure. The storage medium can include various media for storing programming codes including, for example, U-disk, portable hard disk, ROM, RAM, magnetic disk, optical disk, etc.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

1. A speech recognition error correction method, comprising:
obtaining an original word sequence outputted by an automatic speech recognition (ASR) engine based on an input speech signal;
generating a plurality of candidate word sequences, each candidate word sequence being obtained by substituting one or more subsequence of the original word sequence with one or more corresponding replacement sequence based on a phonetic distance between the subsequence and the replacement sequence; and
selecting, among the candidate word sequences, a target word sequence according to generation probabilities of the candidate word sequences, the target word sequence being used to correct the original word sequence;
wherein:
the phonetic distance between the subsequence and the replacement sequence is obtained based on phonetic features of a first phoneme sequence of the subsequence and a second phoneme sequence of the replacement sequence, and the first phoneme sequence and the second phoneme sequence are formed by phonemes used in the automatic speech recognition engine; and
the method further comprises:
extracting the phonetic features associated with the phonemes based on a phonetic alphabet corresponding to the phonemes;
defining a skipping cost function that evaluates a phonetic difference for skipping a phoneme in a phoneme sequence based on the phonetic features, the skipping function for a phoneme m being defined as σₛₖᵢₚ(m)=Σ_{f∈R}f(m)*salience(f), wherein R denotes feature fields and f( ) denotes a function to obtain a feature value in a feature field;
defining a substitution cost function that evaluate a phonetic difference for substituting a phoneme with another phoneme in a phoneme sequence based on the phonetic features, the substitution cost function of substituting phoneme m with phoneme n being defined as σ_{sub}(m,n)=Σ_{f∈R}diff(m,n,f)*salience(f), where R denotes feature fields, f( ) denotes a function to obtain a feature value in a feature field, and diff(m,n,f) denotes a function to obtain an absolute value of a difference value between f(m) and f(n) for a feature field; and
according to the skipping cost function and the substitution cost function, defining the phonetic distance as a minimum number of operations required to transform the first phoneme sequence to the second phoneme sequence, the operations including: skipping a phoneme and substituting a phoneme.

2. The method according to claim 1, further comprising:
obtaining a word-phoneme correspondence reference table for the phonemes used in the ASR engine; and
obtaining the first phoneme sequence and the second phoneme sequence by querying the word-phoneme correspondence reference table.

3. (canceled)

4. The method according to claim 1, wherein:
the phonetic distance Distance(i,j) for a phoneme sequence formed by x₁ to xᵢ and a phoneme sequence formed by y₁ to yⱼ, is defined by:
$$Distance ( i , j ) = min ( \begin{matrix}Distance ( i - 1 , j ) + {σ}_{skip} ( {x}_{i} ) , \\ Distance ( i , j - 1 ) + {σ}_{skip} ( {y}_{j} ) , \\ Distance ( i - 1 , j - 1 ) + {σ}_{sub} ( {x}_{i} , {y}_{j} )\end{matrix} ) , \\ i \leq \vert x \vert , j \leq \vert y \vert$$
wherein σₛₖᵢₚ( ) denotes the skipping function and is σ_{sub}( ) denotes the substitution function.

5. (canceled)

6. The method according to claim 1, wherein extracting the phonetic features comprises:
selecting a plurality of feature fields based on phonetic categories in the phonetic alphabet corresponding to the phonemes used in the acoustic model;
assigning feature values for subcategory phonological terms in each of the plurality of feature fields;
for each of the plurality of feature fields, assigning a corresponding weight; and
calculating the skipping cost function and the substitution cost function based on the assigned feature values and the assigned weights.

7. The method according to claim 1, wherein generating the plurality of candidate word sequences comprises:
for an original word in the original word sequence, obtaining a confusion set corresponding to the original word, the confusion set stores words similar to the original word according to the phonetic distance; and
generating the plurality of candidate word sequences, each candidate word sequence being obtained by substituting one or more original words of the original word sequence with one or more corresponding replacement words, each of the replacement words being obtained from the confusion set of an original word.

8. The method according to claim 7, wherein obtaining the confusion set comprises:
determining similarity scores between any two words in a dictionary used by the ASR engine according to at least phonetic distances between the any two words; and
generating confusion sets for the words in the dictionary based on the similarity scores, each word having a corresponding confusion set that contains one or more word having a similarity score above a threshold.

9. The method according to claim 1, wherein generating the plurality of candidate word sequences comprises:
obtaining a replacement sequence for substituting at least a part of the original word sequence from the ASR engine;
identifying subsequences of the original word sequence;
determining phonetic distances from the replacement sequence to the identified subsequences;
selecting, among the identified subsequences, the candidate subsequences by comparing the corresponding phonetic distances to the replacement sequence; and
generating the plurality of candidate word sequences, each candidate word sequence being obtained by substituting one of the candidate subsequences with the replacement sequence.

10. The method according to claim 1, further comprising:
selecting, among the candidate word sequences, the target word sequence according to the generation probabilities of the candidate word sequences and the phonetic distance between the subsequence and the replacement sequence.

11. A speech recognition error correction apparatus, comprising:
a memory; and
a processor coupled to the memory, the processor being configured to perform:
obtaining an original word sequence outputted by an automatic speech recognition (ASR) engine based on an input speech signal;
generating a plurality of candidate word sequences, each candidate word sequence being obtained by substituting one or more subsequence of the original word sequence with one or more corresponding replacement sequence based on a phonetic distance between the subsequence and the replacement sequence; and
selecting, among the candidate word sequences, a target word sequence according to generation probabilities of the candidate word sequences, the target word sequence being used to correct the original word sequence;
wherein:
the phonetic distance between the subsequence and the replacement sequence is obtained based on phonetic features of a first phoneme sequence of the subsequence and a second phoneme sequence of the replacement sequence, and the first phoneme sequence and the second phoneme sequence are formed by phonemes used in the automatic speech recognition engine; and
the processor is further configured to perform:
extracting the phonetic features associated with the phonemes based on a phonetic alphabet corresponding to the phonemes;
defining a skipping cost function that evaluates a phonetic difference for skipping a phoneme in a phoneme sequence based on the phonetic features, the skipping function for a phoneme m being defined as σₛₖᵢₚ(m)=Σ_{f∈R}f(m)*salience(f), wherein R denotes feature fields and f( ) denotes a function to obtain a feature value in a feature field;
defining a substitution cost function that evaluate a phonetic difference for substituting a phoneme with another phoneme in a phoneme sequence based on the phonetic features, the substitution cost function of substituting phoneme m with phoneme n being defined as σ_{sub}(m,n)=Σ_{f∈R}diff(m,n,f)*salience(f), where R denotes feature fields, f( ) denotes a function to obtain a feature value in a feature field, and diff(m,n,f) denotes a function to obtain an absolute value of a difference value between f(m) and f(n) for a feature field; and
according to the skipping cost function and the substitution cost function, defining the phonetic distance as a minimum number of operations required to transform the first phoneme sequence to the second phoneme sequence, the operations including: skipping a phoneme and substituting a phoneme

12. The apparatus according to claim 11, wherein the processor is further configured to perform:
obtaining a word-phoneme correspondence reference table for the phonemes used in the ASR engine; and
obtaining the first phoneme sequence and the second phoneme sequence by querying the word-phoneme correspondence reference table.

13. (canceled)

14. The apparatus according to claim 11, wherein:
the phonetic distance Distance(i,j) for a phoneme sequence formed by x₁ to xᵢ and a phoneme sequence formed by y₁ to yⱼ, is defined by:
$$Distance ( i , j ) = min ( \begin{matrix}Distance ( i - 1 , j ) + {σ}_{skip} ( {x}_{i} ) , \\ Distance ( i , j - 1 ) + {σ}_{skip} ( {y}_{j} ) , \\ Distance ( i - 1 , j - 1 ) + {σ}_{sub} ( {x}_{i} , {y}_{j} )\end{matrix} ) , \\ i \leq \vert x \vert , j \leq \vert y \vert$$
wherein σₛₖᵢₚ( ) denotes the skipping function and is σ_{sub}( ) denotes the substitution function.

15. (canceled)

16. The apparatus according to claim 11, wherein extracting the phonetic features comprises:
selecting a plurality of feature fields based on phonetic categories in the phonetic alphabet corresponding to the phonemes used in the acoustic model;
assigning feature values for subcategory phonological terms in each of the plurality of feature fields;
for each of the plurality of feature fields, assigning a corresponding weight; and
calculating the skipping cost function and the substitution cost function based on the assigned feature values and the assigned weights.

17. The apparatus according to claim 11, wherein generating the plurality of candidate word sequences comprises:
for an original word in the original word sequence, obtaining a confusion set corresponding to the original word, the confusion set stores words similar to the original word according to the phonetic distance; and
generating the plurality of candidate word sequences, each candidate word sequence being obtained by substituting one or more original words of the original word sequence with one or more corresponding replacement words, each of the replacement words being obtained from the confusion set of an original word.

18. The apparatus according to claim 17, wherein obtaining the confusion set comprises:
determining similarity scores between any two words in a dictionary used by the ASR engine according to at least phonetic distances between the any two words; and
generating confusion sets for the words in the dictionary based on the similarity scores, each word having a corresponding confusion set that contains one or more word having a similarity score above a threshold.

19. The apparatus according to claim 11, wherein generating the plurality of candidate word sequences comprises:
obtaining a replacement sequence for substituting at least a part of the original word sequence from the ASR engine;
identifying subsequences of the original word sequence;
determining phonetic distances from the replacement sequence to the identified subsequences;
selecting, among the identified subsequences, the candidate subsequences by comparing the corresponding phonetic distances to the replacement sequence; and
generating the plurality of candidate word sequences, each candidate word sequence being obtained by substituting one of the candidate subsequences with the replacement sequence.

20. The apparatus according to claim 11, wherein the processor is further configured to perform:
selecting, among the candidate word sequences, the target word sequence according to the generation probabilities of the candidate word sequences and the phonetic distance between the subsequence and the replacement sequence.
